(19) United States
(12) Patent Application Publication
(10) Pub. No.: US 2017/0275171 A1
(43) Pub. Date: Sep. 28, 2017

(54) METHOD FOR PRODUCING OLIGOSILANE

(71) Applicant: SHOWA DENKO K.K., Tokyo (JP)

(72) Inventors: Yoshimitsu ISHIHARA, Tsukuba-shi (JP); Hideaki HAMADA, Tsukuba-shi (JP); Shigeru SHIMADA, Tsukuba-shi (JP); Kazuhiko SATO, Tsukuba-shi (JP); Masayasu IGARASHI, Tsukuba-shi (JP); Hiroshi UCHIDA, Tokyo (JP)

(73) Assignee: SHOWA DENKO K.K., Tokyo (JP)

(21) Appl. No.: 15/504,856

(22) PCT Filed: Aug. 12, 2015
(86) PCT No.: PCT/JP2015/072854

§ 371 Date: Feb. 17, 2017

(30) Foreign Application Priority Data
Aug. 20, 2014 (JP) 2014-167788

(51) Int. Cl. C01B 33/04; B01J 29/70; B01J 29/44; B01J 29/46; B01J 37/08; B01J 29/74; B01J 29/12; B01J 29/40; B01J 37/04

(52) U.S. Cl. CPC C01B 33/04; B01J 29/40; B01J 29/7007; B01J 29/44; B01J 37/04; B01J 37/088; B01J 29/7415; B01J 29/126; B01J 29/7407; B01J 29/7484; B01J 29/46; B01J 2229/20

(57) ABSTRACT

An object of the present invention is to provide a method for producing oligosilane and in particular to provide a method that can efficiently produce oligosilane at lower temperatures and with an improved yield and selectivity. In the dehydrogenative coupling reaction of hydrosilane, oligosilane can be efficiently produced at an improved selectivity for oligosilane, and in particular at an improved selectivity for disilane, by carrying out the reaction in the presence of zeolite having pores with a minor diameter of at least 0.43 nm and a major diameter of not more than 0.69 nm.

### TECHNICAL FIELD

The present invention relates to a method for producing oligosilane and more particularly relates to a method for producing an oligosilane by the dehydrogenative coupling of hydrosilane in the presence of zeolite.

### BACKGROUND ART

Disilanes, which are typical oligosilanes, are useful compounds that can be used as, for example, precursors for the formation of silicon films.

The following methods for producing oligosilanes, for example, have been reported: the acid decomposition of magnesium silicide (refer to NPL 1), the reduction of hexachlorodisilane (refer to NPL 2), electric discharge in a monosilane (refer to PTL 1), the thermal decomposition of a silane (refer to PTL 2 to PTL 4), and the dehydrogenative coupling of silane over a catalyst (refer to PTL 5 to PTL 9).

### CITATION LIST

### Patent Literature

[PTL 1] U.S. Pat. No. 5,478,453 (Specification)
[PTL 2] Japanese Patent No. 4855462 (Specification)
[PTL 3] Japanese Patent Application Laid-open No. H11-260729
[PTL 4] Japanese Patent Application Laid-open No. H03-186314
[PTL 5] Japanese Patent Application Laid-open No. H01-198631
[PTL 6] Japanese Patent Application Laid-open No. H02-184513
[PTL 7] Japanese Patent Application Laid-open No. H05-032785
[PTL 8] Japanese Patent Application Laid-open No. H03-183613
[PTL 9] Japanese Translation of PCT Application No. 2013-506541

### Non Patent Literature

[NPL 1] Hydrogen Compounds of Silicon. I. The Preparation of Mono- and Disilane, WARREN C. JOHNSON and SAMPSON ISENBERG, J. Am. Chem. Soc., 1935, 57, 1349.
[NPL 2] The Preparation and Some Properties of Hydrides of Elements of the Fourth Group of the Periodic System and of their Organic Derivatives, A. E. FINHOLT, A. C. BOND Jr., K. E. WILZBACH and H. I. SCHLESINGER, J. Am. Chem. Soc., 1947, 69, 2692.

### SUMMARY OF INVENTION

### Technical Problem

The acid decomposition of magnesium silicide, reduction of hexachlorodisilane, and electric discharge in monosilane reported as oligosilane production methods generally have tended to readily impose high production costs. There has also been room for improvement with, for example, thermal silane decomposition and catalytic dehydrogenative coupling with regard to the selective synthesis of a particular oligosilane, e.g., disilane.

An object of the present invention is to provide a method for producing oligosilane and in particular to provide a method that can efficiently produce oligosilane at lower temperatures and with an improved yield and selectivity.

### Solution to Problem

As a result of extensive and intensive investigations directed to solving the problem identified above, the present inventors found out that oligosilane could be efficiently produced by the dehydrogenative coupling reaction of a hydrosilane by carrying out the reaction in the presence of zeolite having pores with a specific size. The present invention was achieved based on this finding.

Thus, the present invention is as follows.

<1> A method for producing an oligosilane, comprising a reaction step of producing an oligosilane by dehydrogenative coupling of hydrosilane, wherein the reaction step is carried out in the presence of a zeolite having pores with a minor diameter of at least 0.43 nm and a major diameter of not more than 0.69 nm.
<2> The oligosilane production method according to <1>, wherein the zeolite is at least one type selected from the group consisting of zeolites with the following framework typecodes: AFR, AFY, ATO, BEA, BOG, BPH, CAN, CON, DFO, EON, EZT, GON, IMF, ISV, ITH, IWR, IWV, IWW, MEI, MEL, MFI, OBW, MOZ, MSE, MTT, MTW, NES, OFF, OSI, PON, SFF, SFG, STI, STF, TER, TON, TUN, USI, and VET.
<3> The oligosilane production method according to <1> or <2>, wherein the zeolite is at least one type selected from the group consisting of ZSM-5, beta, and ZSM-22.
<4> The oligosilane production method according to any of <1> to <3>, wherein the zeolite contains a transition metal.
<5> The oligosilane production method according to <4>, wherein the transition metal is at least one type selected from the group consisting of Pt, Pd, Ni, Co, and Fe.
<6> The oligosilane production method according to any of <1> to <5>, wherein the reaction step is carried out in the presence of a hydrogen gas.

### Advantageous Effects of Invention

The present invention can efficiently produce oligosilanes.

### BRIEF DESCRIPTION OF DRAWINGS

FIG. 1 is a schematic diagram of a reactor that can be used in the oligosilane production method of the present invention ((a): batch reactor, (b): continuous tank reactor, (c): continuous tubular reactor).

FIG. 2 is a schematic diagram that shows reaction temperature profiles.

FIG. 3 is a schematic diagram that shows the reaction apparatus used in the examples and comparative examples.

FIG. 4 contains the analytic results from gas chromatography in Example 9.

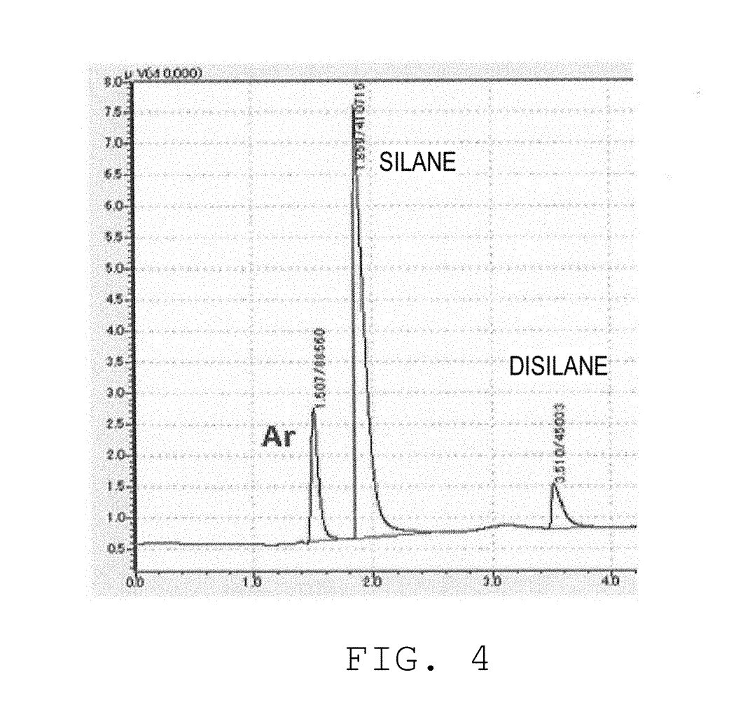

FIG. 5 contains the analytic results from gas chromatography in Comparative Example 1.

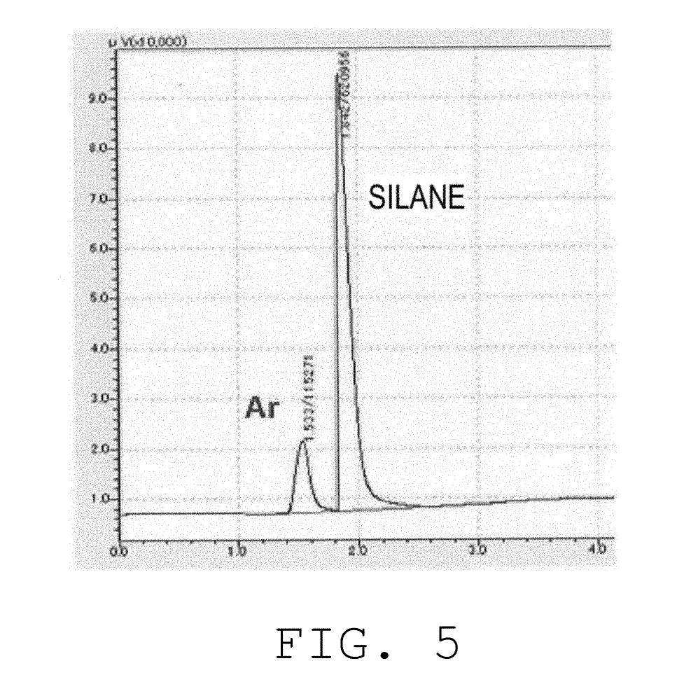

### DESCRIPTION OF EMBODIMENTS

Specific examples will be described in the description of the details of the oligosilane production method of the present invention, but there is no limitation to the following content insofar as there is no departure from the essential features of the present invention and appropriate modifications can be made therein in the execution of the present invention.

<Oligosilane Production Method>

The oligosilane production method that is one aspect of the present invention (also abbreviated below as the “production method of the present invention”) contains a reaction step in which oligosilane is produced by the dehydrogenative coupling of hydrosilane (also abbreviated below as the “reaction step”) and is characterized in that this reaction step is carried out in the presence of a zeolite having pores with a minor diameter of at least 0.43 nm and a major diameter of not more than 0.69 nm.

As a result of extensive investigations into oligosilane production methods, the present inventors found out that, in the dehydrogenative coupling reaction of hydrosilane, oligosilane could be efficiently produced at an improved selectivity for oligosilane, and in particular at an improved selectivity for disilane, by carrying out the reaction in the presence of zeolite having pores with a minor diameter of at least 0.43 nm and a major diameter of not more than 0.69 nm. The effect of the zeolite in this reaction is not entirely clear, but it is thought that the pore space of the zeolite acts as a reaction field for the dehydrogenative coupling and that a pore size defined by a “minor diameter of at least 0.43 nm and a major diameter of not more than 0.69 nm” inhibits an excessive polymerization and thus brings about an enhanced selectivity for oligosilane.

In the present invention, “oligosilane” refers to the silane oligomers provided by the polymerization of a plurality (not more than 10) of individual (mono)silane molecules and specifically includes disilanes, trisilanes, and tetrasilanes. Moreover, “oligosilane” is not limited to only linear oligosilanes, but may be an oligosilane that has, for example, a branched structure, crosslinked structure, or cyclic structure.

In addition, “hydrosilane” refers to a compound that has the silicon-hydrogen (Si—H) bond and specifically includes tetrahydrosilane (SiH₄). The “dehydrogenative coupling of hydrosilane” refers to a reaction in which the silicon-silicon (Si—Si) bond is formed by the coupling between the hydrosilanes with the elimination of hydrogen, as shown, for example, by the following reaction equation.

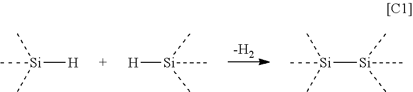

In addition, “zeolite having pores with a minor diameter of at least 0.43 nm and a major diameter of not more than 0.69 nm” does not mean only zeolites that actually have a “minor diameter of at least 0.43 nm and a major diameter of not more than 0.69 nm”, but also includes zeolites for which the pore “minor diameter” and “major diameter” as theoretically calculated from the crystalline structure respectively satisfy the aforementioned conditions. For the pore “minor diameter” and “major diameter”, reference can be made to “ATLAS OF ZEOLITE FRAMEWORK TYPES, Ch. Baerlocher, L. B. McCusker and D. H. Olson, Sixth Revised Edition 2007, published on behalf of the Structure Commission of the International Zeolite Association”.

While the reaction step is characteristically carried out in the presence of zeolite having pores with a minor diameter of at least 0.43 nm and a major diameter of not more than 0.69 nm, there are no particular limitations on the specific numerical values of the pore minor diameter and major diameter other than that they fall in the range of a “minor diameter of at least 0.43 nm and a major diameter of not more than 0.69 nm”.

The minor diameter is at least 0.43 nm, preferably at least 0.45 nm, and particularly preferably at least 0.47 nm.

The major diameter is not more than 0.69 nm, preferably not more than 0.65 nm, and particularly preferably not more than 0.60 nm.

When the pore diameter of the zeolite is constant due to, for example, the cross-sectional structure of the pores being circular, then this is to be regarded as a pore diameter of “at least 0.43 nm and not more than 0.69 nm”.

In the case of a zeolite having a plurality of pore diameters, it is sufficient if the pore diameter of at least one type of pores is “at least 0.43 nm and not more than 0.69 nm”.

The specific zeolite is preferably a zeolite having a framework type code as provided in the database of the International Zeolite Association corresponding to the following: AFR, AFY, ATO, BEA, BOG, BPH, CAN, CON, DFO, EON, EZT, GON, IMF, ISV, ITH, IWR, IWV, IWW, MEI, MEL, MFI, OBW, MOZ, MSE, MTT, MTW, NES, OFF, OSI, PON, SFF, SFG, STI, STF, TER, TON, TUN, USI, and VET.

Zeolites with framework type codes corresponding to the following are more preferred: ATO, BEA, BOG, CAN, IMF, ITH, IWR, IWW, MEL, MFI, OBW, MSE, MTW, NES, OSI, PON, SFF, SFG, STF, STI, TER, TON, TUN, and VET.

Zeolites with framework type codes corresponding to BEA, MFI, and TON are particularly preferred.

Zeolites with a framework type code corresponding to BEA can be exemplified by *Beta (beta), [B—Si—O]-*BEA, [Ga—Si—O]-*BEA, [Ti—Si—O]-*BEA, Al-rich beta, CIT-6, Tschernichite, and pure silica beta (an asterisk indicates a mixed crystal of three polytypes with similar structures).

Zeolites with a framework type code corresponding to MFI can be exemplified by *ZSM-5, [As—Si—O]-MFI, [Fe—Si—O]-MFI, [Ga—Si—O]-MFI, AMS-1B, AZ-1, Bor-C, Boralite C, Encilite, FZ-1, LZ-105, Monoclinic H-ZSM-5, Mutinaite, NU-4, NU-5, Silicalite, TS-1, TSZ, TSZ-III, TZ-01, USC-4, USI-108, ZBH, ZKQ-1B, ZMQ-TB, and organic-free ZSM-5.

Zeolites with a framework type code corresponding to TON can be exemplified by *Theta-1, ISI-1, KZ-2, NU-10, and ZSM-22.

Zeolites ZSM-5, beta, and ZSM-22 are particularly preferred.

The silica/alumina ratio is preferably 5 to 10,000, more preferably 10 to 2,000, and particularly preferably 20 to 1,000.

The zeolite preferably contains a transition metal. The dehydrogenative coupling of the hydrosilane can be accelerated by the incorporation of a transition metal and the oligosilane production can then be carried out more efficiently.

The specific species of transition metal, the form of the transition metal (oxidation number and so forth), the method of incorporating the transition metal, and so forth are described in the following using specific examples but are not particularly limited.

The transition metal can be exemplified by Sc, Ti, V, Cr, Mn, Fe, Co, Ni, Cu, Y, Zr, Nb, Mo, Tc, Ru, Rh, Pd, Ag, La, Ce, Pr, Nd, Pm, Sm, Eu, Gd, Tb, Dy, Ho, Er, Tm, Yb, Lu, Hf, Ta, W, Re, Os, Ir, Pt, Au, Ac, Th, and U. Among these, Group 7 elements (Mn, Tc, Re), Group 8 elements (Fe, Ru, Os), Group 9 elements (Co, Rh, Ir), Group 10 elements (Ni, Pd, Pt), and Group 11 elements (Cu, Ag, Au) are preferred; Pt, Pd, Ni, Co, Fe, Ru, Rh, Ag, Os, Ir, and Au are more preferred; and Pt, Pd, Ni, Co, and Fe are particularly preferred.

The method for incorporating the transition metal can be exemplified by impregnation methods and ion exchange methods. Impregnation methods are methods in which the zeolite is brought into contact with a solution in which the transition metal or the like is dissolved and the transition metal is then adsorbed to the zeolite surface. Ion exchange methods are methods in which the zeolite is brought into contact with a solution in which the transition metal ion is dissolved and the transition metal ion is incorporated at acid sites on the zeolite. Processes such as drying, calcination, and so forth may be carried out after impregnation or ion exchange.

The content of the transition metal in the zeolite is generally at least 0.01 mass % and is preferably at least 0.1 mass % and more preferably at least 0.5 mass %, and is generally not more than 50 mass % and is preferably not more than 20 mass % and more preferably not more than 10 mass %. If within the indicated ranges, oligosilane production can be carried out more efficiently.

The reactor, operating procedure, reaction conditions, and so forth used in the reaction step are not particularly limited and can be selected properly according to the purpose. The reactor, operating procedure, reaction conditions and so forth are described in the following using specific examples, but there is no limitation to this content.

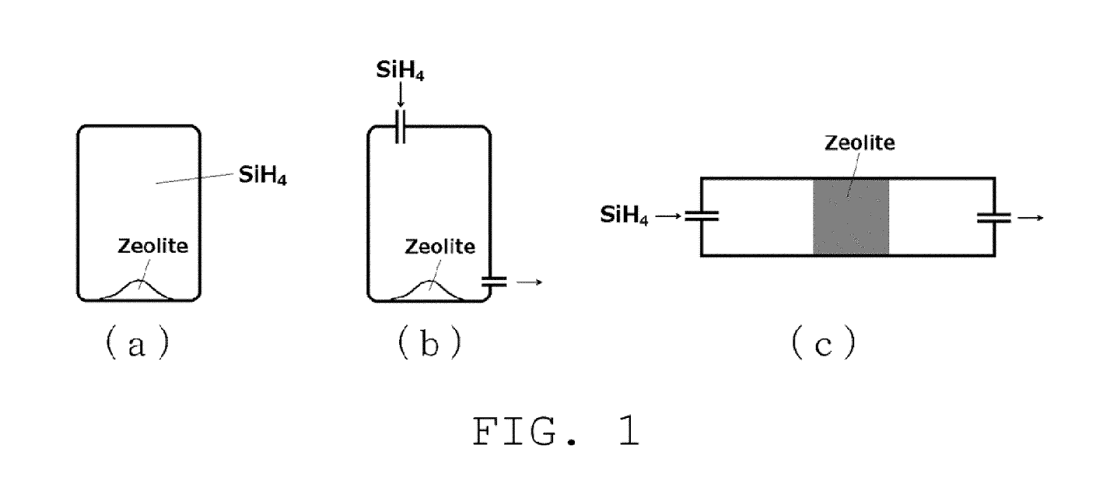

Any of the following reactor types may be used for the reactor: a batch reactor as shown in FIG. 1(a), a continuous tank reactor as shown in FIG. 1(b), and a continuous tubular reactor as shown in FIG. 1(c).

The operating procedure when, for example, a batch reactor is used, can be exemplified by the following method: the dried zeolite is placed in the reactor; the air in the reactor is removed using, for example, a vacuum pump; the hydrosilane and so forth is introduced and sealing is performed; and the reaction is started by raising the interior of the reactor to the reaction temperature. When, on the other hand, a continuous tank reactor or a continuous tubular reactor is used, the operating procedure can be exemplified by the following method: the dried zeolite is placed in the reactor; the air in the reactor is removed using, for example, a vacuum pump; the hydrosilane and so forth is then caused to flow through; and the reaction is started by raising the interior of the reactor to the reaction temperature.

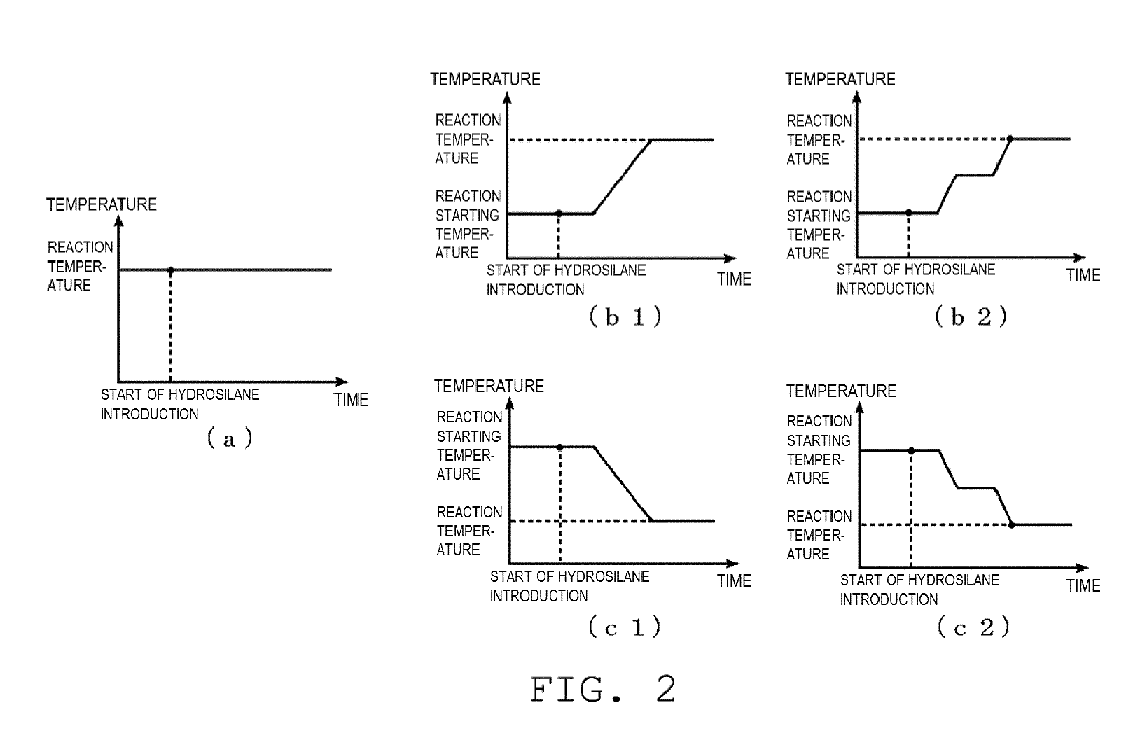

The reaction temperature is generally at least 100° C., preferably at least 150° C., and more preferably at least 200° C., and is generally not more than 450° C., preferably not more than 400° C., and more preferably not more than 350° C. If within the indicated ranges, oligosilane production can be carried out more efficiently. The reaction temperature may be as follows: it may be set at a constant level during the reaction step, as shown in FIG. 2(a); the reaction starting temperature may be set at a low value and the temperature may be raised during the reaction step, as shown in FIGS. 2(b1) and (b2); or the reaction starting temperature may be set at a high value and the temperature may be reduced during the reaction step, as shown in FIGS. 2(c1) and (c2). (The rise in the reaction temperature may be continuous as shown in FIG. 2(b1) or may be stepwise as shown in FIG. 2(b2). Similarly, the fall in the reaction temperature may be continuous as shown in FIG. 2(c1) or may be stepwise as shown in FIG. 2(c2).) In particular, preferably the reaction starting temperature is set at a low value and the reaction temperature is then raised during the reaction step. By setting a low reaction starting temperature, deterioration of the zeolite or the like can be suppressed and oligosilane production can then be carried out more efficiently. The reaction starting temperature when the reaction temperature is raised is generally at least 50° C., preferably at least 100° C., and more preferably at least 150° C., and is generally not more than 350° C., preferably not more than 300° C., and more preferably not more than 250° C.

Compounds other than the hydrosilane and zeolite may be introduced into or passed through the reactor. The compounds other than the hydrosilane and zeolite can be exemplified by gases such as hydrogen gas, helium gas, nitrogen gas, and argon gas and by solids that are almost completely unreactive to the hydrosilane, e.g., silica and titanium hydride, wherein in particular the reaction step is preferably carried out in the presence of hydrogen gas. When hydrogen gas is present, deterioration of the zeolite or the like can be suppressed and oligosilane production can then be carried out in a stable manner on a long-term basis.

While the dehydrogenative coupling of hydrosilane produces disilane (Si₂H₆) as shown in reaction equation (i) below, it is thought that a portion of the produced disilane decomposes, as shown in reaction equation (ii) below, into tetrahydrosilane (SiH₄) and dihydrosilylene (SiH₂). It is also thought that this produced dihydrosilylene undergoes polymerization as shown in reaction equation (iii) below to form a solid polysilane (SiₙH₂ₙ) and that this polysilane adsorbs to the surface of the zeolite and the dehydrogenative coupling activity of the hydrosilane is then lowered and as a consequence the yield of oligosilane, including disilane, is lowered.

When, on the other hand, hydrogen gas is present, it is thought that the dihydrosilylene undergoes decomposition to tetrahydrosilane as shown in reaction equation (iv) below and that the production of polysilane is then suppressed and as a consequence oligosilane can be produced on a long-term and stable basis.

2SiH₄→Si₂H₆+H₂ (i)

Si₂H₆→SiH₄+SiH₂ (ii)

nSiH₂→SiₙH₂ₙ (iii)

SiH₂+H₂→SiH₄ (iv)

The reactor is preferably free of moisture to the greatest extent possible. For example, the zeolite and reactor are preferably thoroughly dried prior to the reaction.

The reaction pressure, considered as the absolute pressure, is generally at least 0.1 MPa and is preferably at least 0.15 MPa and more preferably at least 0.2 MPa, and is generally not more than 1,000 MPa and is preferably not more than 500 MPa and more preferably not more than 100 MPa. The hydrosilane partial pressure is generally at least 0.0001 MPa and is preferably at least 0.0005 MPa and more preferably at least 0.001 MPa, and is generally not more than 100 MPa and is preferably not more than 50 MPa and more preferably not more than 10 MPa. If within the indicated ranges, oligosilane production can be carried out more efficiently.

When the reaction step is carried out in the presence of hydrogen gas, the partial pressure of the hydrogen gas is generally at least 0.01 MPa and is preferably at least 0.03 MPa and more preferably at least 0.05 MPa, and is generally not more than 10 MPa and preferably not more than 5 MPa and more preferably not more than 1 MPa. If within the indicated ranges, oligosilane production can be carried out in a long-term and stable manner.

When a continuous tank reactor or a continuous tubular reactor is used, the flow rate of the hydrosilane to flow through (based on a 0.3 MPa absolute pressure) is, per 1.0 g of zeolite, generally at least 0.01 mL/minute and preferably at least 0.05 mL/minute and more preferably at least 0.1 mL/minute, and generally not more than 1,000 mL/minute and preferably not more than 500 mL/minute and more preferably not more than 100 mL/minute. If within the indicated range, oligosilane production can be carried out more efficiently.

When the reaction step is run in the presence of hydrogen gas, the flow rate of the hydrogen gas to flow through (based on a 0.2 MPa absolute pressure) is, per 1.0 g of zeolite, generally at least 0.01 mL/minute and preferably at least 0.05 mL/minute and more preferably at least 0.1 mL/minute, and generally not more than 100 mL/minute and preferably not more than 50 mL/minute and more preferably not more than 10 mL/minute. If within the indicated ranges, oligosilane production can be carried out in a long-term and stable manner.

### EXAMPLES

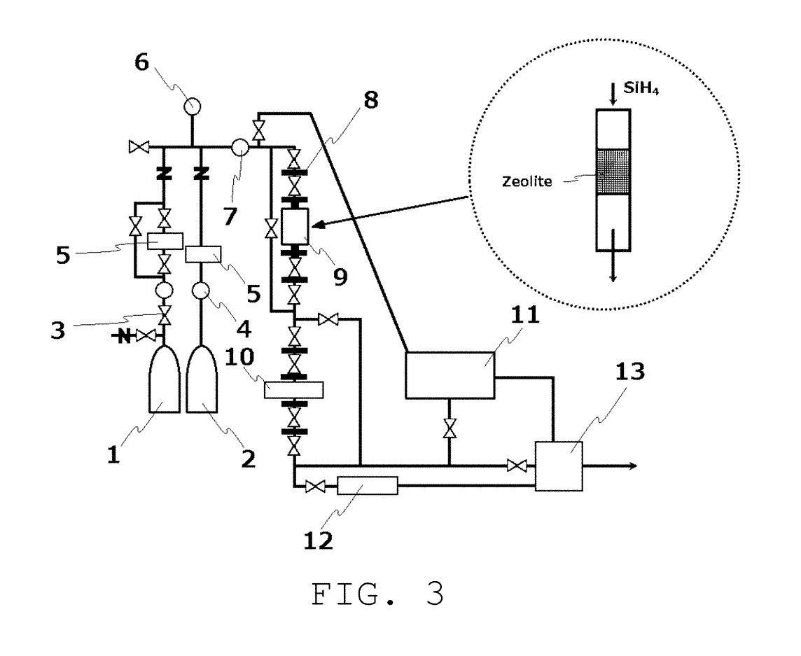

The present invention is described in additional detail using the examples and comparative examples provided below, but modifications can be made as appropriate insofar as there is no departure from the essential features of the present invention. Accordingly, the scope of the present invention should not be construed as being limited to or by the specific examples given below. The examples and comparative examples were carried out by immobilizing the zeolite in a fixed bed within the reaction tube of the reaction apparatus shown in FIG. 3 (schematic diagram) and flowing through a reaction gas containing tetrahydrosilane that had been diluted with helium gas or the like. The produced gas was analyzed using a GC-17A gas chromatograph from Shimadzu Corporation with a TCD detector. A yield of 0% was reported when detection by GC did not occur (below the detection limit). Qualitative analysis of the disilane and so forth was performed by MASS (mass analyzer). The pores in the zeolites used are as follows.

A type zeolite (framework type code: LTA, includes Na-A type zeolite, Ca-A type zeolite, and so forth):

<100> minor diameter=0.41 nm, major diameter=0.41 nm

ZSM-5 (framework type code: MFI, includes H-ZSM-5, NH₄-ZSM-5, and so forth):

<100> minor diameter=0.51 nm, major diameter=0.55 nm

<010> minor diameter=0.53 nm, major diameter=0.56 nm

beta (framework type code: BEA):

<100> minor diameter=0.66 nm, major diameter=0.67 nm

minor diameter=0.56 nm, major diameter=0.56 nm

ZSM-22 (framework type code: TON):

minor diameter=0.46 nm, major diameter=0.57 nm

Y type zeolite (framework type code: FAU, includes H—Y type zeolite, Na—Y type zeolite, and so forth):

<111> minor diameter=0.74 nm, major diameter=0.74 nm

The numerical values for the pore minor diameter and major diameter are taken from “http://www.jaz-online.org/introduction/qanda.html” and “ATLAS OF ZEOLITE FRAMEWORK TYPES, Ch. Baerlocher, L. B. McCusker and D. H. Olson, Sixth Revised Edition 2007, published on behalf of the Structure Commission of the International Zeolite Association”.

### Production of Oligosilane in the Presence of Zeolite

### Example 1

1.0 g of H-ZSM-5(90) (silica/alumina ratio=90, JRC-Z5-90H(1) reference catalyst from the Catalysis Society of Japan) was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute, and this time point was designated as the reaction starting time (elapsed time=0 hours). The temperature within the reaction tube (the reaction temperature) was varied as shown in Table 1. Between each reaction temperature, the temperature was raised over 20 minutes and the temperature was then held constant after the particular reaction temperature had been reached. The examples described below were carried out in the same manner. The composition of the reaction gas was analyzed by gas chromatography after each time period had elapsed. The silane conversion was calculated from the decline in the GC area for the silane using Ar as the internal standard. The disilane yield was calculated from the GC area for disilane using Ar as the internal standard. The selectivity for disilane was calculated from disilane yield/silane conversion. The same was also done in the examples that follow. The results are given in Table 1.

TABLE 1

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 200 | 2 | 5 | 1.2 | 22 |
| 250 | 3 | 11 | 1.7 | 16 |
| 300 | 4 | 7 | 2.6 | 36 |
| 350 | 5 | 7 | 3.1 | 45 |

### Example 2

1.0 g of a ZSM-5 type high-silica zeolite (silica/alumina ratio=800, refer to: Zeolite Catalyzed Ozonolysis. A Major Qualifying Project Proposal submitted to the Faculty and Staff of WORCESTER POLYTECHNIC INSTITUTE for requirements to achieve the Degree of Bachelor of Science in Chemical Engineering, By: Dave Carlone, Bryan Rickard, and Anthony Scaccia, product name: HISIV-3000) was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 2. The composition of the reaction gas was analyzed by gas chromatography after each time period had elapsed and the silane conversion, disilane yield, and selectivity for disilane were calculated. The results are given in Table 2.

TABLE 2

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 200 | 1 | 3 | 0.6 | 20 |
| 250 | 2 | 1 | 0.8 | 85 |
| 300 | 3 | 3 | 0.9 | 27 |
| 350 | 4 | 21 | 1.4 | 7 |

### Example 3

1.0 g of beta (silica/alumina ratio=25, JRC-Z-HB25(1) reference catalyst from the Catalysis Society of Japan) was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature was raised to 300° C. over 2 hours. After 3 hours after 300° C. had been reached, the composition of the reaction gas was analyzed by gas chromatography with the following results: the silane conversion was 1.8%; the disilane yield was 1.8%; and the selectivity for disilane was 98%. The results are given in Table 3.

TABLE 3

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 250 | 1 | 97 | 0.0 | 0 |
| 300 | 2 | 98 | 0.0 | 0 |
| 300 | 3 | 53 | 0.0 | 0 |
| 300 | 4 | 1.3 | 1.2 | 92 |
| 300 | 5 | 1.8 | 1.8 | 98 |

### Example 4

1.0 g of beta (silica/alumina ratio=25, JRC-Z-B25(1) reference catalyst from the Catalysis Society of Japan) was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 4. The composition of the reaction gas was analyzed by gas chromatography after each time period had elapsed and the silane conversion, disilane yield, and selectivity for disilane were calculated. The results are given in Table 4.

TABLE 4

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 250 | 1 | 74 | 0.0 | 0 |
| 300 | 2 | 31 | 0.4 | 1 |
| 350 | 3 | 26 | 0.7 | 3 |

### Comparative Example 1

Without filling catalyst into the reaction tube, the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was brought to 300° C. as shown in Table 5. The composition of the reaction gas was analyzed by gas chromatography after each time period had elapsed and the silane conversion, disilane yield, and selectivity for disilane were calculated. The results are given in Table 5.

TABLE 5

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 300 | 1 | 0 | 0.0 | 0 |

### Comparative Example 2

Without filling catalyst into the reaction tube, the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was brought to 400° C. as shown in Table 6. The composition of the reaction gas was analyzed by gas chromatography after each time period had elapsed and the silane conversion, disilane yield, and selectivity for disilane were calculated. The results are given in Table 6.

TABLE 6

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 400 | 1 | 2.7 | 2.1 | 78 |

### Comparative Example 3

2.0 g of Na—Y type zeolite (unknown silica/alumina ratio, USKY-700 molecular sieve from Union Showa K.K.) was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 7. The composition of the reaction gas was analyzed by gas chromatography after each time period had elapsed and the silane conversion, disilane yield, and selectivity for disilane were calculated. The results are given in Table 7.

TABLE 7

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 250 | 1 | 31 | 0.0 | 0 |
| 300 | 2 | 8 | 0.0 | 0 |
| 300 | 3 | 0 | 0.0 | 0 |
| 350 | 4 | 0 | 0.0 | 0 |

### Comparative Example 4

A Ca-A type zeolite (unknown silica/alumina ratio, product name: Molecular Sieve 5A, pellets) was pulverized to give a powder, and 2.0 g of this was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 8. The composition of the reaction gas was analyzed by gas chromatography after each time period had elapsed and the silane conversion, disilane yield, and selectivity for disilane were calculated. The results are given in Table 8.

TABLE 8

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 250 | 1 | 0 | 0.0 | 0 |
| 300 | 2 | 0 | 0.0 | 0 |
| 300 | 3 | 1 | 0.0 | 0 |
| 350 | 4 | 0 | 0.0 | 0 |

### Comparative Example 5

An Na-A type zeolite (unknown silica/alumina ratio, product name: Molecular Sieve 4A, pellets) was pulverized to give a powder, and 2.0 g of this was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 9. The composition of the reaction gas was analyzed by gas chromatography after each time period had elapsed and the silane conversion, disilane yield, and selectivity for disilane were calculated. The results are given in Table 9.

TABLE 9

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 250 | 1 | 0 | 0.0 | 0 |
| 300 | 2 | 2 | 0.0 | 0 |
| 300 | 3 | 19 | 0.0 | 0 |
| 350 | 4 | 14 | 0.0 | 0 |

### Comparative Example 6

1.0 g of H—Y type zeolite (silica/alumina ratio=5.5, JRC-Z-HY5.5 reference catalyst from the Catalysis Society of Japan) was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 10. The composition of the reaction gas was analyzed by gas chromatography after each time period had elapsed and the silane conversion, disilane yield, and selectivity for disilane were calculated. The results are given in Table 10.

TABLE 10

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 200 | 1 | 31 | 0.0 | 0 |
| 250 | 2 | 8 | 0.0 | 0 |
| 300 | 3 | 0 | 0.0 | 0 |
| 350 | 4 | 0 | 0.0 | 0 |

### Preparation of Pt-Loaded Zeolite

### Preparative Example 1

4 g of distilled water and 0.102 g of K₂PtCl₄ (corresponded to 4% loading as Pt) were added to 1.2 g of NH₄-ZSM-5 (silica/alumina ratio=30, JRC-Z5-30NH4(1) reference catalyst from the Catalysis Society of Japan) and mixing was carried out for 1 hour at room temperature. This was followed by drying at 110° C. and then calcination for 1 hour at 300° C. to obtain Pt-loaded ZSM-5 in powder form.

### Preparative Example 2

6 g of distilled water and 0.043 g of K₂PtCl₄ (corresponded to 1% loading as Pt) were added to 2.0 g of NH₄-ZSM-5 (silica/alumina ratio=30, JRC-Z5-30NH4(1) reference catalyst from the Catalysis Society of Japan) and mixing was carried out for 1 hour at room temperature. This was followed by drying at 110° C. and then calcination for 1 hour at 300° C. to obtain Pt-loaded ZSM-5 in powder form.

### Preparative Example 3

6 g of distilled water and 0.043 g of K₂PtCl₄ (corresponded to 1% loading as Pt) were added to 2.0 g of NH₄-ZSM-5 (silica/alumina ratio=23, from Tosoh Corporation, product name: HSZ-800 type 820NHA) and mixing was carried out for 1 hour at room temperature. This was followed by drying at 110° C. and then calcination for 1 hour at 300° C. to obtain Pt-loaded ZSM-5 in powder form.

### Preparative Example 4

6 g of distilled water and 1.09 g of a nitric acid solution of dinitrodiammineplatinum (Pt concentration=4.6%, from Tanaka Kikinzoku Kogyo KK) (corresponded to 1% loading as Pt) were added to 5.0 g of NH₄-ZSM-5 (silica/alumina ratio=23, from Tosoh Corporation, product name: HSZ-800 type 820NHA) and mixing was carried out for 1 hour at room temperature. This was followed by drying at 110° C. and then calcination for 1 hour at 500° C. to obtain Pt-loaded ZSM-5 in powder form.

### Preparative Example 5

6 g of distilled water and 0.78 g of a nitric acid solution of Pt(NH₃)₄(NO₃)₂ (Pt concentration=6.4%, from N.E. Chemcat Corporation) (corresponded to 1% loading as Pt) were added to 5.0 g of NH₄-ZSM-5 (silica/alumina ratio=23, from Tosoh Corporation, product name: HSZ-800 type 820NHA) and mixing was carried out for 1 hour at room temperature. This was followed by drying at 110° C. and then calcination for 1 hour at 500° C. to obtain Pt-loaded ZSM-5 in powder form.

### Preparative Example 6

6 g of distilled water and 1.88 g of a nitric acid solution of Pt(NH₃)₄(NO₃)₂ (Pt concentration=6.4%, from N.E. Chemcat Corporation) (corresponded to 4% loading as Pt) were added to 3.0 g of NH₄-ZSM-5 (silica/alumina ratio=23, from Tosoh Corporation, product name: HSZ-800 type 820NHA) and mixing was carried out for 1 hour at room temperature. This was followed by drying at 110° C. and then calcination for 1 hour at 500° C. to obtain Pt-loaded ZSM-5 in powder form.

### Preparative Example 7

6 g of distilled water and 0.39 g of a nitric acid solution of Pt(NH₃)₄(NO₃)₂ (Pt concentration=6.4%, from N.E. Chemcat Corporation) (corresponded to 0.5% loading as Pt) were added to 5.0 g of NH₄-ZSM-5 (silica/alumina ratio=23, from Tosoh Corporation, product name: HSZ-800 type 820NHA) and mixing was carried out for 1 hour at room temperature. This was followed by drying at 110° C. and then calcination for 1 hour at 500° C. to obtain 1% Pt-loaded ZSM-5 in powder form.

### Preparative Example 8 (Ion-Exchange Method)

6 g of distilled water and 0.78 g of a nitric acid solution of Pt(NH₃)₄(NO₃)₂ (Pt concentration=6.4%, from N.E. Chemcat Corporation) (corresponded to 1% loading as Pt) were added to 5.0 g of NH₄-ZSM-5 (silica/alumina ratio=23, from Tosoh Corporation, product name: HSZ-800 type 820NHA) and mixing was carried out for 4 hours at room temperature. This was followed by standing still overnight and then filtration and washing with water. The obtained solid was dried at 110° C. and then calcined for 1 hour at 500° C. to obtain Pt-loaded ZSM-5 in powder form.

### Preparative Example 9

6 g of distilled water and 1.06 g of K₂PtCl₄ (corresponded to 1% loading as Pt) were added to 5.0 g of beta (silica/alumina ratio=25, JRC-Z-HB25 (1) reference catalyst from the Catalysis Society of Japan) and mixing was carried out for 1 hour at room temperature. This was followed by drying at 110° C. and then calcination for 1 hour at 500° C. to obtain Pt-loaded beta in powder form.

### Preparative Example 10

10 g of distilled water and 1.02 g of K₂PtCl₄ (corresponded to 1% loading as Pt) were added to 4.9 g of H—Y type zeolite (silica/alumina ratio=5.5, JRC-Z-HY5.5 reference catalyst from the Catalysis Society of Japan) and mixing was carried out for 1 hour at room temperature. This was followed by drying at 110° C. and then calcination for 1 hour at 500° C. to obtain Pt-loaded Y type zeolite in powder form.

### Preparative Example 11

An Na-A type zeolite (unknown silica/alumina ratio, product name: Molecular Sieve 4A, pellets) was pulverized to give a powder, and to 3.3 g of this powder were added 5 g of distilled water and 0.077 g of K₂PtCl₄ (corresponded to 1% loading as Pt) and mixing was carried out for 1 hour at room temperature. This was followed by drying at 110° C. and then calcination for 1 hour at 500° C. to obtain Pt-loaded A type zeolite in powder form.

### Preparative Example 12

10 g of distilled water and 0.31 g of a nitric acid solution of Pt(NH₃)₄(NO₃)₂ (Pt concentration=6.4%, from N.E. Chemcat Corporation) (corresponded to 1% loading as Pt) were added to 2.0 g of K-ZSM-22 (silica/alumina ratio=69, from ACS Material, LLC) and mixing was carried out for 1 hour at room temperature. This was followed by drying at 110° C. and then calcination for 1 hour at 500° C. to obtain Pt-loaded ZSM-22 in powder form.

### Production of Oligosilane in the Presence of Pt-Loaded Zeolite

### Example 5

1.0 g of the 4% Pt-loaded ZSM-5 prepared in Preparative Example 1 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 11. The composition of the reaction gas was analyzed by gas chromatography after each time period had elapsed and the silane conversion, disilane yield, and selectivity for disilane were calculated. The results are given in Table 11.

TABLE 11

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 200 | 1 | 68 | 0.0 | 0 |
| 250 | 2 | 34 | 1.8 | 5 |
| 300 | 3 | 20 | 6.9 | 34 |
| 300 | 4 | 12 | 10.5 | 86 |

### Example 6

1.0 g of the 1% Pt-loaded ZSM-5 prepared in Preparative Example 2 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 12. The composition of the reaction gas was analyzed by gas chromatography after each time period had elapsed and the silane conversion, disilane yield, and selectivity for disilane were calculated. The results are given in Table 12.

TABLE 12

| temperature | | | | selectivity |
|---|---|---|---|---|
| in the | | silane | | for |
| reaction | elapsed | conversion | disilane | disilane |
| tube [° C.] | time [h] | [%] | yield [%] | [%] |
| 150 | 1 | 30 | 0.7 | 2 |
| 200 | 2 | 21 | 2.1 | 10 |
| 250 | 3 | 14 | 5.0 | 35 |
| 300 | 4 | 9 | 8.7 | 100 |

### Example 7

1.0 g of the 1% Pt-loaded ZSM-5 prepared in Preparative Example 3 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was set as shown in Table 13. The composition of the reaction gas was analyzed by gas chromatography after each time period had elapsed and the silane conversion, disilane yield, and selectivity for disilane were calculated. The results are given in Table 13.

TABLE 13

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 300 | 1 | 20 | 5.8 | 29 |
| 300 | 2 | 24 | 5.4 | 23 |
| 300 | 3 | 23 | 5.1 | 22 |
| 300 | 4 | 6.3 | 6.2 | 97 |
| 300 | 5 | 8.0 | 7.5 | 94 |
| 300 | 6 | 8.1 | 6.2 | 77 |
| 300 | 7 | 5.7 | 5.8 | 100 |
| 300 | 8 | 5.2 | 5.4 | 100 |
| 300 | 9 | 4.7 | 4.7 | 100 |
| 300 | 10 | 4.8 | 4.8 | 99 |

### Example 8

1.0 g of the 1% Pt-loaded ZSM-5 prepared in Preparative Example 4 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 14. The composition of the reaction gas was analyzed by gas chromatography after each time period had elapsed and the silane conversion, disilane yield, and selectivity for disilane were calculated. The results are given in Table 14.

TABLE 14

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 150 | 1 | 54 | 0.0 | 0 |
| 200 | 2 | 36 | 0.7 | 2 |
| 250 | 3 | 37 | 1.5 | 4 |
| 300 | 4 | 25 | 4.2 | 17 |
| 300 | 5 | 11 | 5.6 | 49 |
| 300 | 6 | 5 | 5.1 | 99 |

### Example 9

1.0 g of the 1% Pt-loaded ZSM-5 prepared in Preparative Example 5 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 15. The composition of the reaction gas was analyzed by gas chromatography after each time period had elapsed and the silane conversion, disilane yield, and selectivity for disilane were calculated. The results are given in Table 15.

TABLE 15

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 200 | 1 | 14 | 4.5 | 32 |
| 250 | 2 | 27 | 6.0 | 22 |
| 300 | 3 | 25 | 10.0 | 40 |
| 300 | 4 | 21 | 11.3 | 55 |
| 300 | 5 | 12 | 10.1 | 83 |
| 300 | 6 | 9 | 8.7 | 100 |

### Example 10

1.0 g of the 4% Pt-loaded ZSM-5 prepared in Preparative Example 6 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 16. The composition of the reaction gas was analyzed by gas chromatography after each time period had elapsed and the silane conversion, disilane yield, and selectivity for disilane were calculated. The results are given in Table 16.

TABLE 16

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 200 | 1 | 37 | 3.4 | 9 |
| 250 | 2 | 38 | 3.9 | 10 |
| 300 | 3 | 27 | 7.6 | 28 |
| 300 | 4 | 32 | 8.1 | 26 |
| 300 | 5 | 16 | 7.6 | 47 |

### Example 11

1.0 g of the 0.5% Pt-loaded ZSM-5 prepared in Preparative Example 7 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 17. The composition of the reaction gas was analyzed by gas chromatography after each time period had elapsed and the silane conversion, disilane yield, and selectivity for disilane were calculated. The results are given in Table 17.

TABLE 17

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 200 | 1 | 5 | 1.2 | 23 |
| 250 | 2 | 30 | 2.4 | 8 |
| 300 | 3 | 25 | 4.0 | 16 |
| 300 | 4 | 15 | 4.6 | 32 |
| 300 | 5 | 4 | 4.1 | 92 |
| 300 | 6 | 4 | 3.9 | 96 |

### Example 12

1.0 g of the 1% Pt-loaded ZSM-5 prepared in Preparative Example 8 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 18. The composition of the reaction gas was analyzed by gas chromatography after each time period had elapsed and the silane conversion, disilane yield, and selectivity for disilane were calculated. The results are given in Table 18.

TABLE 18

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 200 | 1 | 37 | 3.5 | 9 |
| 250 | 2 | 36 | 4.3 | 12 |
| 300 | 3 | 26 | 7.0 | 27 |
| 300 | 4 | 18 | 10.1 | 57 |
| 300 | 5 | 15 | 11.5 | 77 |
| 300 | 6 | 18 | 9.9 | 56 |

### Example 13

1.0 g of the 1% Pt-loaded beta prepared in Preparative Example 9 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 19. The composition of the reaction gas was analyzed by gas chromatography after each time period had elapsed and the silane conversion, disilane yield, and selectivity for disilane were calculated. The results are given in Table 19.

TABLE 19

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 300 | 1 | 37 | 0.8 | 2 |
| 300 | 2 | 12 | 1.1 | 9 |
| 300 | 3 | 6.5 | 1.8 | 27 |

### Example 14

1.0 g of the 1% Pt-loaded ZSM-22 prepared in Preparative Example 12 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 10 mL/minute and the temperature within the reaction tube was varied as shown in Table 20. The composition of the reaction gas was analyzed by gas chromatography after each time period had elapsed and the silane conversion, disilane yield, and selectivity for disilane were calculated. The results are given in Table 20.

TABLE 20

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 200 | 1 | 1.6 | 0.4 | 28 |
| 250 | 2 | 3.8 | 1.3 | 34 |
| 300 | 3 | 7.4 | 1.3 | 18 |
| 300 | 4 | 2.9 | 2.0 | 68 |
| 300 | 5 | 2.1 | 1.8 | 86 |

### Comparative Example 7

1.0 g of the 1% Pt-loaded Y type zeolite prepared in Preparative Example 10 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 21. The composition of the reaction gas was analyzed by gas chromatography after each time period had elapsed and the silane conversion, disilane yield, and selectivity for disilane were calculated. The results are given in Table 21.

TABLE 21

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 200 | 1 | 14 | 0.0 | 0 |
| 250 | 2 | 14 | 0.0 | 0 |
| 300 | 3 | 23 | 0.0 | 0 |
| 350 | 4 | 21 | 0.0 | 0 |

### Comparative Example 8

1.0 g of the 1% Pt-loaded A type zeolite prepared in Preparative Example 11 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 22. The composition of the reaction gas was analyzed by gas chromatography after each time period had elapsed and the silane conversion, disilane yield, and selectivity for disilane were calculated. The results are given in Table 22.

TABLE 22

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 200 | 1 | 0 | 0.0 | 0 |
| 250 | 2 | 0 | 0.0 | 0 |
| 300 | 3 | 13 | 0.0 | 0 |
| 350 | 4 | 7 | 0.0 | 0 |

### Preparation of Transition Metal-Loaded Zeolite

### Preparative Example 13

6 g of distilled water and 0.25 g of Co(NO₃)₂.6H₂O (corresponded to 1% loading as Co) were added to 5.0 g of NH₄-ZSM-5 (from Tosoh Corporation, product name: 820NHA) and mixing was carried out for 1 hour at room temperature. This was followed by drying at 110° C. and then calcination for 1 hour at 500° C. to obtain 1% Co-loaded ZSM-5 in powder form.

### Preparative Example 14

6 g of distilled water and 0.11 g of NiCl₂ (corresponded to 1% loading as Ni) were added to 5.0 g of NH₄-ZSM-5 (from Tosoh Corporation, product name: 820NHA) and mixing was carried out for 1 hour at room temperature. This was followed by drying at 110° C. and then calcination for 1 hour at 500° C. to obtain 1% Ni-loaded ZSM-5 in powder form.

### Preparative Example 15

6 g of distilled water and 0.11 g of Pd(NO₃)₂ (corresponded to 1% loading as Pd) were added to 5.0 g of NH₄-ZSM-5 (from Tosoh Corporation, product name: 820NHA) and mixing was carried out for 1 hour at room temperature. This was followed by drying at 110° C. and then calcination for 1 hour at 500° C. to obtain 1% Pd-loaded ZSM-5 in powder form.

### Preparative Example 16

6 g of distilled water and 0.11 g of Pd(NO₃)₂ (corresponded to 1% loading as Pd) were added to 5.0 g of NH₄-ZSM-5 (from Tosoh Corporation, product name: 820NHA) and mixing was carried out for 1 hour at room temperature. This was followed by drying at 110° C. and then calcination for 2 hours at 500° C. to obtain 1% Pd-loaded ZSM-5 in powder form.

### Production of Oligosilane in the Presence of Transition Metal-Loaded Zeolite

### Example 15

1.0 g of the 1% Co-loaded ZSM-5 prepared in Preparative Example 13 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 23. The composition of the reaction gas was analyzed by gas chromatography after each time period had elapsed and the silane conversion, disilane yield, and selectivity for disilane were calculated. The results are given in Table 23.

TABLE 23

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 200 | 1 | 13 | 4.4 | 34 |
| 250 | 2 | 23 | 3.8 | 17 |
| 300 | 3 | 16 | 5.0 | 31 |
| 300 | 4 | 10 | 4.0 | 39 |

### Example 16

1.0 g of the 1% Ni-loaded ZSM-5 prepared in Preparative Example 14 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 24. The composition of the reaction gas was analyzed by gas chromatography after each time period had elapsed and the silane conversion, disilane yield, and selectivity for disilane were calculated. The results are given in Table 24.

TABLE 24

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 200 | 1 | 52 | 1.4 | 3 |
| 250 | 2 | 50 | 2.1 | 4 |
| 300 | 3 | 18 | 7.2 | 40 |
| 300 | 4 | 6 | 4.0 | 70 |

### Example 17

1.0 g of the 1% Pd-loaded ZSM-5 prepared in Preparative Example 15 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 8 mL/minute and helium gas at 40 mL/minute were mixed in a gas mixer and passed through. After 5 minutes, the argon/silane mixed gas was brought to 1 mL/minute and the helium gas was brought to 20 mL/minute and the temperature within the reaction tube was varied as shown in Table 25. The composition of the reaction gas was analyzed by gas chromatography after each time period had elapsed and the silane conversion, disilane yield, and selectivity for disilane were calculated. The results are given in Table 25.

TABLE 25

| temperature | | | | selectivity |
|---|---|---|---|---|
| in the | elapsed | silane | disilane | for |
| reaction | time | conversion | yield | disilane |
| tube [° C.] | [h] | [%] | [%] | [%] |
| 200 | 1 | 29 | 0.7 | 2 |
| 250 | 2 | 23 | 0.8 | 4 |
| 300 | 3 | 4 | 2.8 | 71 |
| 300 | 4 | 5 | 4.7 | 98 |

### Influence of the Reaction Temperature in Oligosilane Production

### Example 18

A reaction was carried out as in Example 9, but changing the temperature program in the reaction tube to the conditions described in Table 26. The results are given in Table 26.

TABLE 26

| | temperature | | | | selectivity |
|---|---|---|---|---|---|
| | in the | elapsed | silane | disilane | for |
| | reaction | time | conversion | yield | disilane |
| | tube [° C.] | [h] | [%] | [%] | [%] |
| Example | 350 | 1 | 17 | 3.2 | 19 |
| 18 | 300 | 2 | 6 | 3.5 | 56 |
| | 300 | 3 | 3 | 3.0 | 93 |
| | 300 | 4 | 3 | 2.5 | 100 |
| | 300 | 5 | 4 | 2.6 | 70 |
| Example | 200 | 1 | 14 | 4.5 | 32 |
| 9 | 250 | 2 | 27 | 6.0 | 22 |
| | 300 | 3 | 25 | 10.0 | 40 |
| | 300 | 4 | 21 | 11.3 | 55 |
| | 300 | 5 | 12 | 10.1 | 83 |
| | 300 | 6 | 9 | 8.7 | 100 |

A comparison of Examples 1 to 18 with Comparative Examples 1 and 2 demonstrates that, by using the catalyst of the present invention, disilane is produced even at conditions that are at least 100° C. lower than in the absence of catalyst.

### Production of Oligosilane in the Presence of Transition Metal-Loaded Zeolite and Hydrogen Gas

### Example 19

2.0 g of the 1% Pd-loaded ZSM-5 prepared in Preparative Example 16 was placed in the reaction tube and the air was removed from the reaction tube using a vacuum pump and substitution with helium gas was then carried out. The helium gas was passed through at a rate of 40 mL/minute and the temperature was raised to 200° C., after which the helium gas was passed through for 1 hour. Then, an argon/silane mixed gas (Ar: 20%, SiH₄: 80% (volume ratio)) at 4 mL/minute, hydrogen gas at 6 mL/minute, and helium gas at 10 mL/minute were mixed in a gas mixer and passed through. The composition of the reaction gas was analyzed by gas chromatography after each time period had elapsed and the silane conversion, disilane yield, and selectivity for disilane were calculated. The results are given in Table 27.

The decline in the disilane yield even after the passage of 7 hours is insignificant, and it is thus shown that deterioration in the 1% Pd-loaded ZSM-5 is suppressed by the addition of hydrogen to the reaction gas.

TABLE 27

| temperature | | | | selectivity | |
|---|---|---|---|---|---|
| in the | elapsed | silane | disilane | for | |
| reaction | time | conversion | yield | disilane | STY |
| tube [° C.] | [h] | [%] | [%] | [%] | [g/kgh] |
| 200 | 1 | 5.1 | 2.4 | 48 | 3.1 |
| 200 | 2 | 8.1 | 2.6 | 33 | 3.4 |
| 200 | 3 | 7.3 | 2.6 | 35 | 3.3 |
| 200 | 4 | 3.2 | 2.2 | 69 | 2.8 |
| 200 | 7 | 2.8 | 2.1 | 75 | 2.7 |

### INDUSTRIAL APPLICABILITY

Disilane obtained in accordance with the production method of the present invention can be expected to be useful as a gas for the production of silicon for semiconductors.

### REFERENCE SIGNS LIST

1 Tetrahydrosilane gas (SiH₄) cylinder
2 Helium gas (He) cylinder
3 Emergency shutoff valve (gas inspection shutoff valve)
4 Pressure reduction valve
5 Mass flow controller (MFC)
6 Pressure gauge
7 Gas mixer
8 Joint
9 Heated reaction apparatus
10 Trap
11 Rotary pump
12 System gas chromatograph
13 Abatement apparatus

1. A method for producing an oligosilane, comprising a reaction step of producing an oligosilane by dehydrogenative coupling of hydrosilane, wherein the reaction step is carried out in the presence of a zeolite having pores with a minor diameter of at least 0.43 nm and a major diameter of not more than 0.69 nm.

2. The oligosilane production method according to claim 1, wherein the zeolite is at least one type selected from the group consisting of zeolites with the following framework type codes: AFR, AFY, ATO, BEA, BOG, BPH, CAN, CON, DFO, EON, EZT, GON, IMF, ISV, ITH, IWR, IWV, IWW, MEI, MEL, MFI, OBW, MOZ, MSE, MTT, MTW, NES, OFF, OSI, PON, SFF, SFG, STI, STF, TER, TON, TUN, USI and VET.

3. The oligosilane production method according to claim 1, wherein the zeolite is at least one type selected from the group consisting of ZSM-5, beta, and ZSM-22.

4. The oligosilane production method according to claim 1, wherein the zeolite contains a transition metal.

5. The oligosilane production method according to claim 4, wherein the transition metal is at least one type selected from the group consisting of Pt, Pd, Ni, Co, and Fe.

6. The oligosilane production method according to claim 1, wherein the reaction step is carried out in the presence of a hydrogen gas.

7. The oligosilane production method according to claim 2, wherein the zeolite contains a transition metal.

8. The oligosilane production method according to claim 7, wherein the transition metal is at least one type selected from the group consisting of Pt, Pd, Ni, Co, and Fe.

9. The oligosilane production method according to claim 3, wherein the zeolite contains a transition metal.

10. The oligosilane production method according to claim 9, wherein the transition metal is at least one type selected from the group consisting of Pt, Pd, Ni, Co, and Fe.

11. The oligosilane production method according to claim 2, wherein the reaction step is carried out in the presence of a hydrogen gas.

12. The oligosilane production method according to claim 3, wherein the reaction step is carried out in the presence of a hydrogen gas.

13. The oligosilane production method according to claim 4, wherein the reaction step is carried out in the presence of a hydrogen gas.

14. The oligosilane production method according to claim 5, wherein the reaction step is carried out in the presence of a hydrogen gas.

15. The oligosilane production method according to claim 7, wherein the reaction step is carried out in the presence of a hydrogen gas.

16. The oligosilane production method according to claim 8, wherein the reaction step is carried out in the presence of a hydrogen gas.

17. The oligosilane production method according to claim 9, wherein the reaction step is carried out in the presence of a hydrogen gas.

18. The oligosilane production method according to claim 10, wherein the reaction step is carried out in the presence of a hydrogen gas.
